(19) United States
(12) Patent Application Publication
(10) Pub. No.: US 2010/0245117 A1
(43) Pub. Date: Sep. 30, 2010

(54) SYSTEM FOR DETECTING AN OBJECT IN A MONITORING AREA

(75) Inventors: René Hug, Mels (CH); Gerhard Bräuer, Chur (CH); Heinz Hügli, Bonaduz (CH)

Correspondence Address: BURR & BROWN, PO BOX 7068, SYRACUSE, NY, 13261-7068, US

(73) Assignee: Cedes AG, Landquart (CH)

(21) Appl. No.: 12/774,797

(22) Filed: May 6, 2010

Related U.S. Application Data
(63) Continuation of application No. PCT/EP2008/009412, filed on Nov. 7, 2008.

(30) Foreign Application Priority Data
Nov. 7, 2007 (DE) 10 2007 053 557.2
Jun. 16, 2008 (DE) 10 2008 028 280.4

(51) Int. Cl. H02J 13/00; H04B 10/06; H04B 1/06

(52) U.S. Cl. 340/825.52; 398/202; 367/135

(57) ABSTRACT

A system for detecting an object in a monitoring area with a plurality of sensors, each including a transmitter and a receiver, and an electronics unit for evaluating the receivers. The electronics unit is capable of assigning a contact address to a transmitter and/or to a receiver, wherein address assignment is effected such that after the address assignment it is possible for the electronics unit to associate receivers with transmitters.

### CROSS REFERENCE TO RELATED APPLICATIONS

This application is a continuation of International Application No. PCT/EP2008/009412 filed Nov. 7, 2008, which designated the United States, and claims the benefit under 35 USC §119(a)-(d) of German Application No. 10 2007 053 557.2 filed Nov. 7, 2007 and German Application No. 10 2008 028 280.4 filed Jun. 16, 2008, the entireties of which are incorporated herein by reference.

### FIELD OF THE INVENTION

The invention relates to a system for detecting an object in a monitoring area.

### BACKGROUND OF THE INVENTION

Systems are known in which single light barriers with a transmitter and a receiver are connected to one another via filter elements, which allow global evaluation of the resultant light barrier network. That is to say that a signal is available regarding whether or not a light barrier is interrupted in the light barrier field.

### SUMMARY OF THE INVENTION

The invention is based on the object of improving evaluation of a cluster comprising a plurality of sensors, each comprising a transmitter and a receiver.

The invention is based on a system for detecting an object in a monitoring area which comprises a plurality of sensors each comprising at least one transmitter and at least one receiver, and an electronics unit for evaluating the receivers. The electronics unit is capable of assigning a contact address to a transmitter and/or receiver, and address assignment is effected such that after the address assignment it is possible for the electronics unit to associate specific receivers with specific transmitters.

The system according to the invention can be used, by way of example, for monitoring large monitoring areas, such as in the case of escalators, sidewalks, sluices, doors or gates, with the sensors being monitored by a controller. By way of example, to cover escalators, monitoring intervals of 30 cm in the straight part and 20 cm in the curved part are required pursuant to the European standard. Frequently, escalators have no sensory monitoring. After a power failure, the escalator can be switched on only when it has been established that nobody is on the escalator. In the case of escalators without sensory monitoring, the escalator is therefore switched on manually, in which case it is necessary to check beforehand whether the escalator is actually empty. This is comparatively complicated. What is desired is automatic startup, which is possible with sensor monitoring. In known sensory monitoring systems for escalators, a large number of light barriers are used in order to be able to implement the aforementioned monitoring intervals. These light barriers operate autonomously and deliver a signal to a controller via a common line. This has the drawback that it is not possible to tell which light barrier is transmitting an object detection signal. This is also problematical in the case of a fault, because all the light barriers have to be checked separately in order to find the fault. The practice according to the invention does not encounter such drawbacks, since the electronics unit can immediately recognize, on the basis of the addressing and association of receivers and transmitters, which receiver in a sensor pair is the origin of an object detection signal, for example. If this receiver cannot detect any object whatsoever because there is none present, there must be a fault in the sensor.

Preferably, the assignment of contact addresses should be effected such that after the distribution of the addresses the physical order of the transmitters and receivers and hence also any pairing in the system, e.g. a bus, is available to the electronics unit.

Furthermore, it is particularly advantageous if receivers and/or transmitters are arranged in separate units.

The arrangement of receivers/transmitters in separate units means that the system is not tied to prescribed detection resolutions or monitoring lengths, as is the case with ready-made light curtains.

The invention is particularly advantageous when a large number of sensors are used which need to be synchronized, and in this context installations of different shape and size need to be monitored.

A separate unit of a receiver may contain a plurality of receivers. It is also conceivable for at least one receiver and a transmitter to be accommodated in a unit, for example if the receiver receives a signal from the transmitter via reflection means.

In one particularly preferred embodiment of the invention, the electronics unit is designed to evaluate receivers selectively. This can be done, by way of example, by hiding individual receivers during the evaluation or by virtue of the receiver being designed such that it can be disconnected completely by means of the electronics unit. Which receivers participate in object evaluation can therefore be determined by the electronics unit. Such a practice is also advantageous for synchronizing transmitters and receivers. This is because it is possible for different synchronization patterns to be prescribed from the electronics unit. By way of example, the electronics unit triggers a pulse on a transmitter, whereupon a check is performed by selectively selecting the receiver to determine whether the receiver has received the pulse in the desired manner and has provided an appropriate signal for the electronics unit.

This also allows crosstalk effects to be detected if, by way of example, the associated receiver is not evaluated for a transmitter signal but rather adjacent receivers are read by the electronics unit.

In order to be able to implement a multiplicity of check and object recognition patterns, it is preferred if the electronics unit is designed to be able to actuate transmitters specifically.

In one particularly preferred embodiment of the invention, receivers are designed to produce a receiver-related object recognition signal. By way of example, the receiver transmits a recognition signal, for example an address, when an object is detected.

Furthermore, it is preferred if the electronics unit is designed to be able to evaluate patterns regarding the order in which receivers recognize an object. By way of example, this allows the direction of movement of an object to be detected in a monitored area.

In addition, it is preferred if the electronics unit is designed to address the receivers sequentially for evaluation. By way of example, the receivers are connected to a line which is interrupted by the respective receiver. This line can be used to send an activation signal, with the activation signal being advanced from receiver to receiver on the basis of a prescribed clock, for example. Whenever a receiver is active as a result of the activation signal, the receiver signal is evaluated. This measure means that the electronics unit “knows” not only which receiver is possibly delivering an object detection signal but also where this receiver is arranged physically in the chain of receivers, naturally on the basis of the manner in which the receivers are wired.

This implements a kind of “shift register” evaluation for the receivers. A corresponding practice can be implemented for actuating the transmitters.

Sensors comprising at least one transmitter and at least one receiver can operate particularly on the basis of light and/or ultrasound. Many known sensor types may be used, such as single light barriers, hybrid light barriers, light pushbuttons, 2D and 3D sensors operating on the basis of known techniques, such as time of light, pulse transit time or the stereo principle, camera sensors, reflection light sensors, light barriers with multiple light beams (light curtains), sensor and receiver systems which use a reflector, to name but a few options.

The units which accommodate the receivers preferably comprise a housing which can be connected to an adjacent housing by means of plug connectors, for example. Both transmitters and receivers are accommodated in separate housings, for example, which can be respectively connected to one another by means of plug connectors. In this way, an arrangement on a sensor network comprising interconnected receivers, on the one hand, and interconnected transmitters, on the other hand, can be installed quickly and safely over long distances, particularly for the purpose of monitoring large escalators.

In order to provide an operator with a rapid overview of the sensor state, it is also possible for the electronics unit to comprise indicator means, for example a visual indicator like an LED, which indicates which receiver detects an object.

In addition, it is advantageous if the indicator means indicate whether a receiver and/or transmitter is faulty. The failure of a sensor can be recognized, by way of example by virtue of communication on the bus no longer taking place or a receiver receiving a signal even though none has been emitted.

In addition, it is possible for the electronics unit to be designed to evaluate signals from a plurality of sensors in order to infer a fault. By way of example, two transmitter/receiver pairs are assembled at the same location. Accordingly, the pairs must always output the same. If the electronics unit receives different signals then there must be a fault.

In order to provide a particularly flexible system, it is also possible for transmitters and receivers to be connected to the electronics unit by means of a bus system. Standard bus systems are conceivable, such as CAN, SPI or EUSART bus. Preferably, a line between the sensors is not interrupted. Sensor elements are preferably simply put onto a prescribed bus line.

In one embodiment, the bus system may be a “two-wire bus”. Accordingly, the supply of power and also addressing and/or evaluation take place via two lines. In this case, address signals and/or evaluation signals are preferably modeled onto the power supply.

A connection point for a sensor preferably has an ASIC arranged on it which sits on the two-wire bus and is designed such that communication with the electronics unit can take place. As ASIC is an application-specific integrated circuit.

In a further particularly preferred embodiment of the invention, transmitters and receivers are arranged opposite, but with the transmitters and receivers respectively being situated on different sides. An alternate arrangement is also possible, in which on one side a transmitter is followed by a receiver from the next transmitter/receiver pair. This allows crosstalk effects to be minimized.

Transmitters and receivers may, in principle, have separate housings, with both transmitters and receivers being connected to a bus system. Preferably, transmitters and receivers can each be addressed individually.

It is possible for the transmitters and receivers to be situated on the same bus system. In this way, only one bus system, e.g. a ring bus, is required. In principle, the number of transmitters and receivers does not have to be the same. By way of example, a receiver evaluates a plurality of transmitters or a transmitter serves a plurality of receivers.

It is also preferred if the electronics unit has connections for a bus. This measure allows the electronics unit to be produced in a simple manner, since only one connection per bus run is required.

It is also preferred if the electronics unit is designed to ascertain the speed, direction of movement or size of objects, for example, using the sensor signals. In order to provide this functionality, a teach-in mode may be provided. Furthermore, the transmitters and receivers can be actuated such that they are disconnected if they are not needed. This allows power to be saved and/or the service life to be increased.

The receivers may be designed such that evaluation of pulses from transmitters is possible. By way of example, the transmitters can send signals freely, with the receivers automatically being synchronized to the transmitter signals, e.g. pulses. The bus is preferably used to request only the state of the receiver.

In an additionally preferred embodiment of the invention, transmitters and/or receivers can be snapped onto a bus line in a simple manner. In this case, the transmitters and/or receivers and/or a base block may be in a form such that a data line is interrupted in the process, so that the transmitters and/or receivers are in a series circuit in the data line following attachment.

So that a desired bus topology is produced, it is possible for the transmitters and/or receivers to already have connecting cables and plug connectors. The plug connectors can then preferably be used to electrically connect adjacent transmitters or receivers to one another directly or via an adapter.

### BRIEF DESCRIPTION OF THE DRAWINGS

Several exemplary embodiments of the invention are illustrated in the drawings and are explained in more detail below with indications of further advantages and details.

FIG. 1 shows a schematic basic illustration of a sensor network comprising independent sensors and receivers;

FIG. 2 shows the coupling of a receiver or transmitter to a supply line or data line in a schematic block diagram;

FIG. 3 shows a corresponding illustration to that in FIG. 2 of a further option for coupling a transmitter and/or receiver to a supply/data line;

FIG. 4 shows a schematic illustration of a bus line with coupling points;

FIG. 5 shows an illustration comparable to that in FIG. 1 of a sensor network with alternately arranged transmitter/receiver pairs;

FIGS. 6 and 7 show a schematic illustration of two options for electrically connecting transmitters and receivers; and

FIG. 8 shows a schematic detail from a data bus with bus subscribers.

### DETAILED DESCRIPTION OF THE INVENTION

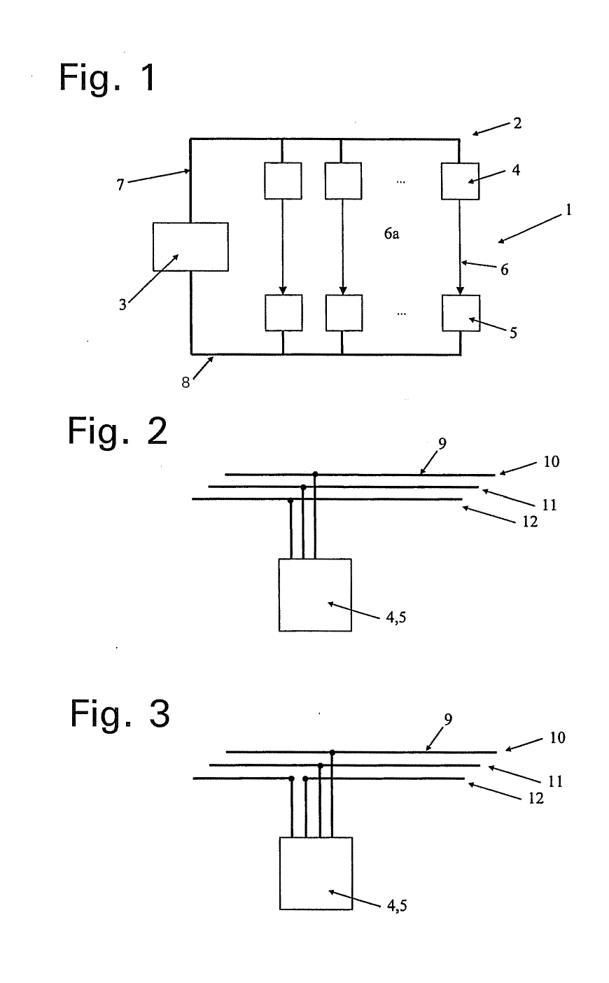

FIG. 1 depicts a monitoring system 1 comprising a sensor network 2 and a controller 3. The sensor network 2 contains a multiplicity of pairs of transmitters 4 and receivers 5.

Each transmitter 4 and each receiver 5 is preferably in the form of a separate unit. All the transmitters and receivers 4, 5 are connected to the controller 3. The transmitters 4 emit light, for example, particularly infrared light, which is received by the opposite receiver in the respective receiver pair. FIG. 1 symbolizes a light beam by means of a respective arrow 6.

The transmitters 4 are connected to the controller by means of a connecting line 7. The receivers 5 are connected to the controller 3 by a connecting line 8.

By way of example, the controller 3 is capable of sequentially assigning contact addresses to the receivers 5 and the transmitters 4, so that after the assignment by the sequential selection it is possible to derive a physical order and hence also the arrangement of receiver/transmitter pairs for appropriate processing by the controller 3.

The light beams 6 can be used to monitor a comparatively large monitoring area 6a for objects which are in place or crop up. By way of example, a monitoring system 1 is connected to an escalator controller, with the sensors 4, 5 monitoring the escalator for objects. After a power failure, the escalator can start up automatically provided that sensors 4, 5 do not detect an object in the monitored area 6a.

FIG. 2 shows a connecting line 9 to which transmitters or receivers 4, 5 are electrically connected. By way of example, the connecting line 9 has three wires, with two wires 10, 11 being used to supply current and a third wire 12 being used as a data line. By way of example, the data line 12 is used by the controller 3 to address the receiver 5 or transmitter 4 for the purpose of transmitting a signal, or performing an evaluation if the receiver 5 is involved.

FIG. 3 shows an alternative way of connecting a receiver/transmitter 4, 5 to the connecting line 9.

The wires 10 and 11 in the connecting line 9 provide the supply of current for the respective receiver/transmitter 4, 5, as in FIG. 2. However, the data line 12 is interrupted by the respective receiver/transmitter 4, 5. If the data line 12 is used to send an activation signal, for example, which arrives with the first transmitter 4, thus activating the latter, a signal is transmitted. A receiver delivers an evaluation signal, for example, upon activation.

In the next clock cycle, the transmitter or receiver which is next on the data line 12 is activated, and the previously activated transmitter or receiver is deactivated again.

Hence, explicit evaluation of a transmitter/receiver pair is always possible. In addition, the controller knows which pair of transmitter and receiver is currently being evaluated on the basis of the clock cycle.

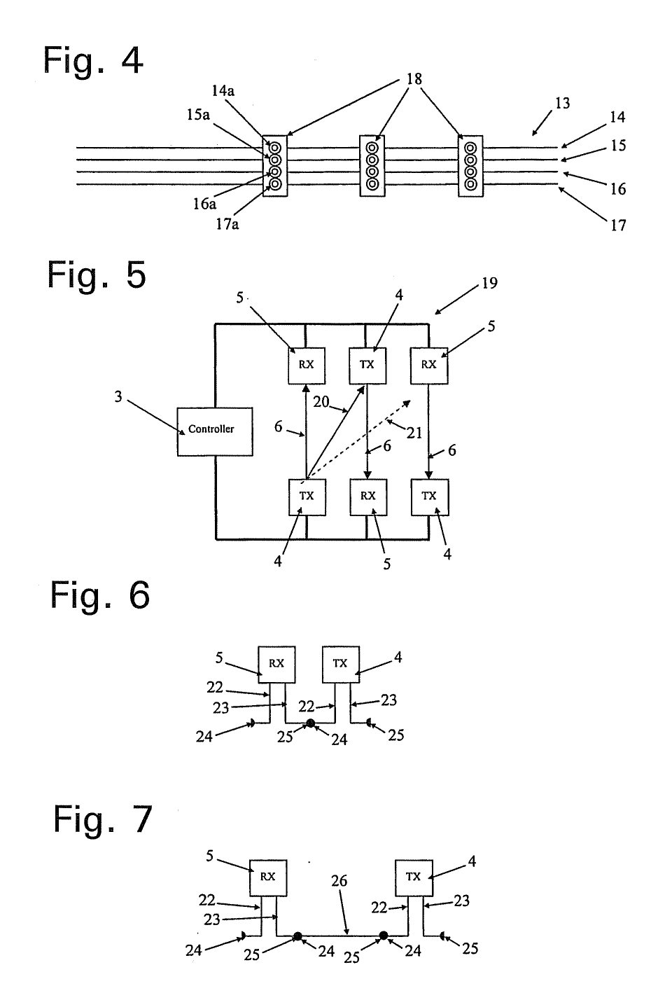

FIG. 4 shows a schematic illustration of a bus line 13 with four wires 14-17. The bus line has plug connector elements 18 put on, for example clipped on, without interrupting the bus line 13, said plug connector elements 18 providing a connection contact 14a to 17a for each wire 14-17. Such a plug connector element can easily have a receiver 5 or transmitter 4 plugged in using a suitable mating component. The intervals between the plug connector elements 18 can be individually designed for the desired positioning of the sensors.

FIG. 5 depicts a monitoring system 19 which comprises pairs of transmitters 4 and receivers 5 for producing monitoring light beams 6, said pairs of transmitter 4 and receiver 5 being arranged alternately, so that on one side a transmitter 4 is followed by a receiver 5 and the receiver 5 is in turn followed by a transmitter 4.

This has the advantage that a transmitter 4 likewise finds a transmitter 4 on the opposite side adjacent to the associated receiver 5, the latter transmitter being unaffected by a crosstalk light beam 20, that is to say a light beam which does not travel to the associated receiver 5. A light beam 21 ought already to be produced so that a receiver 5 which is the next but one is reached. Such a marked crosstalk response is improbable given corresponding dimensioning, however, which means that this arrangement can be used to achieve a relatively high level of safety during the monitoring.

FIGS. 6 and 7 show two interconnection examples for transmitters 4 and receivers 5. Each transmitter 4 and receiver 5 has two connecting lines 22, 23, the ends of which have a respective plug connector element 24, 25 connected to them. The plug connector elements 24, 25 are preferably designed such that it is only possible to make a meaningful connection to a transmitter and/or receiver. In FIG. 6, the receiver 5 has been electrically connected to a transmitter 4, for example.

To be able to span relatively long distances, in particular, connecting cables 26 which are equipped with appropriate plug connector elements 24, 25 are also conceivable. Such a combination is depicted in FIG. 7.

The plug connector elements are preferably designed such that only prescribed combinations are possible, e.g. plug connector element 24 can only be combined with a plug connector element 25. This allows incorrect connections to be prevented.

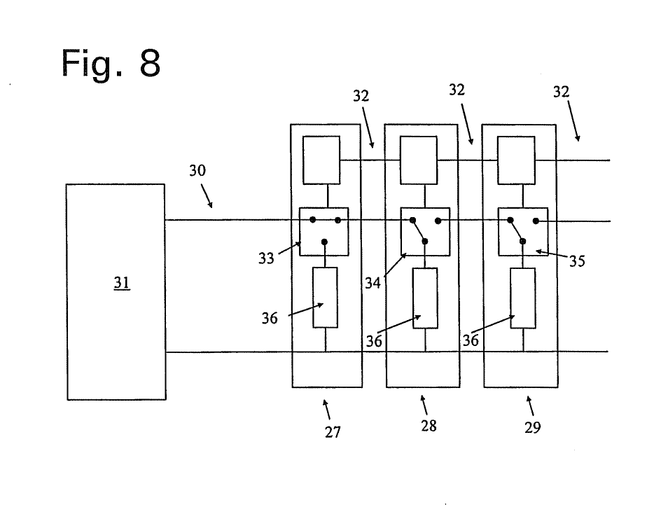

FIG. 8 is intended to illustrate the aspect of the invention which relates to the distribution of addresses to bus subscribers 27, 28, 29, e.g. receivers or transmitters, on a data bus 30.

In FIG. 8, the three bus subscribers 27, 28, 29 are connected to a controller 31 by means of the data bus 30. In addition, adjacent bus subscribers are connected to one another by means of a connection 32. In an initial state, the bus subscribers 27, 28, 29 have no assigned addresses.

The bus subscribers 27, 28, 29 have switching units 33, 34, 35.

While a bus subscriber has no address, the switching unit 33, 34, 35 is in a switching state such that a terminating element, e.g. a terminating resistor 36, electrically terminates the bus.

In FIG. 8, the bus subscribers 28 and 29 are in this switching position, which means that the middle bus subscriber 28 forms the bus termination by means of the terminating resistor 36.

The further bus subscriber 29 is decoupled from the bus by the switch position of the switching unit 34.

The controller 31 can therefore communicate with the bus subscriber 27 and the bus subscriber 28. For the purpose of address allocation, the controller 31 sends an appropriate piece of information to all the bus subscribers which have not yet been provided with an address. In line with FIG. 8, the bus subscriber 28 can receive this information. The further bus subscriber 29 is isolated from the bus. The bus subscriber 27 has already received an address.

As soon as a bus subscriber has received an address, the switching unit 33 is put into a switching position, as depicted in the bus subscriber 27, so that the next bus subscriber to follow, in the present case the bus subscriber 28, can be contacted for the purpose of addressing. Precisely this state is shown in FIG. 8. The effect achieved by this is that the bus subscribers can automatically be provided with an address, and this means that the physical order of the bus subscribers is necessarily available to the controller 31.

When all the bus subscribers have been addressed, no further terminating resistors are connected, but rather all the switching units 33, 34, 35 are in a switching state, as illustrated in the bus subscriber 27.

So as nevertheless to ensure that the data bus 30 is electrically terminated in the desired manner, for example in order to prevent signal reflections, appropriate measures allow the terminating resistor in the last module, e.g. by virtue of a timer or from the analysis of the communication which is taking place on the bus, to connect the terminating resistor 36 again.

It is also conceivable for a bus subscriber which does not yet have an address to output a signal to the respective neighbor. Only when a bus subscriber has received an address and furthermore also receives a signal from a neighbor is the switching unit 33, 34, 35 changed over. In this way, although the last bus subscriber in the order is being addressed, the switching unit 35 is left in the switching position which applies the terminating resistor 36 to the data bus 30.

### LIST OF REFERENCE SYMBOLS

1 Monitoring system
2 Sensor network
3 Controller
4 Transmitter
5 Receiver
6 Light beam
6a Monitoring area
7 Connecting line
8 Connecting line
9 Connecting line
10 Wire
11 Wire
12 Wire
13 Bus line
14 Wire
14a Connection contact
15 Wire
15a Connection contact
16 Wire
16a Connection contact
17 Wire
17a Connection contact
18 Plug connector element
19 Monitoring system
20 Light beam
21 Light beam
22 Connecting line
23 Connecting line
24 Plug connector element
25 Plug connector element
26 Connecting cable
27 Bus subscriber
28 Bus subscriber
29 Bus subscriber
30 Data bus
31 Controller
32 Connection
33 Switching unit
34 Switching unit
35 Switching unit
36 Terminating resistor

We claim:

1. A system for detecting an object in a monitoring area comprising a plurality of sensors, each comprising at least one transmitter and at least one receiver, and an electronics unit for evaluating the receivers, wherein the electronics unit assigns a contact address to at least one of a transmitter and receiver so as to allow the electronics unit to associate specific receivers with specific transmitters.

2. The system as claimed in claim 1, wherein at least one of the transmitters and receivers are arranged in separate units.

3. The system as claimed in claim 1, wherein the electronics unit selectively evaluates the receivers.

4. The system as claimed in claim 1, wherein the receivers produce a receiver-related object recognition signal.

5. The system as claimed in claim 1, wherein the electronics unit addresses the receivers sequentially for evaluation.

6. The system as claimed in claim 1, wherein the electronics unit evaluates patterns for the order in which receivers recognize an object.

7. The system as claimed in claim 1, wherein the receivers operate on the basis of light.

8. The system as claimed in claim 1, wherein the receivers operate on the basis of ultrasound.

9. The system as claimed in claim 1, wherein at least one of the receivers and transmitters are connected to one another by means of plug connectors.

10. The system as claimed in claim 1, wherein the electronics unit comprises an indicator for indicating which receiver detects an object.

11. The system as claimed in claim 1, wherein the electronics unit actuates transmitters specifically.

12. The system as claimed in claim 1, wherein at least one of the transmitters and receivers are connected to the electronics unit by means of a bus system.

13. The system as claimed in claim 1, wherein the transmitters and receivers are arranged on opposite sides of the monitoring area.

14. The system as claimed in claim 13, wherein all transmitters are arranged on one side of the monitoring area and all receivers are arranged on the other side of the monitoring area.

15. The system as claimed in claim 13, wherein, in a first transmitter/receiver pair, the transmitter is arranged on one side of the monitoring area and the receiver is arranged on the other side of the monitoring area, and in an adjacent transmitter/receiver pair, the transmitter is arranged on said other side of the monitoring area and the receiver is arranged on said one side of the monitoring area.
